(19) United States
(12) Patent Application Publication
(10) Pub. No.: US 2008/0209308 A1
(43) Pub. Date: Aug. 28, 2008

(54) CONTENT REFERENCE LINKING PURCHASE MODEL

(76) Inventor: Nicholas Andrew Brackney, Kent, WA (US)

Correspondence Address: Nicholas A. Brackney, 10700 SE 260th St. Unit P102, Kent, WA, 98030, US

(21) Appl. No.: 11/751,055

(22) Filed: May 21, 2007

Related U.S. Application Data
(60) Provisional application No. 60/802,330, filed on May 22, 2006.

(51) Int. Cl. G06F 17/00

(52) U.S. Cl. 715/205

(57) ABSTRACT

A model for the distribution of additional content referenced inside of a file. Wherein a link is inserted into the work to allow users to purchase or receive additional content through non-invasive means.

### CROSS-REFERENCE TO RELATED APPLICATIONS

This application claims the benefit of provisional patent application Ser. No. 60/802,330, filed 2006 May 22 by the present inventor.

### FEDERALLY SPONSORED RESEARCH

Not applicable

### SEQUENCE LISTING OR PROGRAM

Not Applicable

### BACKGROUND OF THE INVENTION

### Field of Invention

This invention relates to online purchase models, specifically to purchasing based off of referenced content found in a like work.

### BACKGROUND OF THE INVENTION

### Prior Art

Hypertext linking is commonly used to push users to related information, most often attached advertising or other websites. Such linking builds the fundamental backbone for all eCommerce and websites in general.

The origin of this technology can be traced back to the Project Xandu in 1960 founded by Ted Nelson. Project Xandu led to a paper to the ACM in 1965 on “zippered lists” which could facilitate a compounded document from pieces of other documents. Later he would publish his ideas in “Computer Lib/Dream Machines” ISBN 0914845497 (1974). In the end while Project Xandu was a success in terms of spurring creativity and innovation it failed to achieve any marketable success.

The first instance of this technology to gain widespread acceptance was with the facsimile. Such a bulky and time consuming medium, which typically only yielded a one way communication until the other party was able to read, write a response and resend, resulted in a need for a more expedited system. Therefore inventors created a system by which a computer could interpret a particular response in a field and feedback the relevant data being requested. U.S. Pat. No. 4,893,333 to Baran et. al. (1990) discloses a method by which the computer could analyze the user's request and immediately send the related information back to the user with no human interaction. Inherently the problem with such a system is it relies on user provided information which takes time, and also a method of transfer, faxing, which is no longer a preferred mode of communication for most consumers.

The other early mover in hypertext linking was Tim Bemers-Lee while at CERN he conceived the World Wide Web. Originally in 1980 he proposed the project but it wasn't until 1989 that he started to create it. On Aug. 6, 1991 the web's first site was published.

The general movement in hypertext linking as a commercial enterprise has moved more towards advertising revenue generation. However, Xerox was granted U.S. Pat. No. 6,486,895 to Robertson et. al. (2002) for a display system of like documents. They referred to the grouping of hypertext linked like files as a WebBook. This embodiment is sorely lacking in that their intent was in designing a display based system and not a marketplace for customers.

The next step in hypertext linking was to use it to embed advertising into digital content U.S. Pat. No. 6,725,203. This method doesn't represent the interests of consumers or content providers as it imposes advertising which stands in the way of the end-user experience. Even with matching ads by content you end up with an intrusion by directing customers away from the content they have already decided to purchase or review.

### BACKGROUND OF INVENTION

### Objects And Advantages

Accordingly, besides the objects and advantages of my invention are:
(a) Embedded linking that is available in offline sessions for future use when connectivity is reestablished adds value.
(b) Reference linking offers end users a more enjoyable experience
(c) Non-invasive marketing of like goods increases brand awareness and brand image for content providers.
(d) Offering an easy to use purchase system enriches the end user's experience by offering access to more goods that they wish to procure.
(e) By marketing auxiliary, ancillary, and accompanying materials inside the digital content the content provider will see significant and measurable increases in sales
(f) Linking will be expanded into video as well as text or image based linking creating a new way to reach consumers inside video.
(g) The dialog box that pops up will allow the user to save content to the library or open immediately, this allows the user to determine their rate of consumption to enrich the experience.

Still further objects and advantages will become apparent from consideration of the ensuing description and drawings.

### SUMMARY

In view of the aforementioned short-comings of presently available schemes for linking documents to digital content, one objective of the present invention is to overcome these short-comings of conventional existing systems.

Another object of the invention is to use linking as a method of propagating the purchase of more referenced materials.

Yet another object of the invention is to provide an unobtrusive marketplace and purchase model that will not interfere with the end user experience or consumption of the main good.

### DRAWINGS—FIGURES

In the drawings, closely related figures have the same number but different alphabetic suffixes.

FIG. 1.A shows a process the user goes through from the time they see the reference link to the end result of buying or not buying.

FIG. 2.A is a top perspective view of an exemplary digital publication or digitized copy displayed on a screen that is used to display information downloaded from an external source.

FIG. 2.B is an angled perspective view of digital publication or digitized copy displayed on a screen, in such a way as to imply movement or a turned page to end-user, which is used to display information downloaded from an external source.

FIG. 2.C is an angled perspective that mimics an open book showing 2 pages.

FIG. 2.D is a top down view at two pages connected, with referencing text, referenced imagery or both being used to access the Purchasing Dialog box, which is shown outside of the two pages.

FIG. 2.E is a top down view of two pages connected with a reference image box being used to access a purchasing dialog box that pops up and is being placed over the article that is currently being displayed.

FIG. 2.F is a top down view of one page being displayed, with a reference text being used to access a purchasing dialog box that pops up and is placed over the article that is currently being displayed.

FIG. 3.A is a top down view of two pages being displayed with reference linking being used to blow up (make larger) an image on the page.

### DRAWING

### Reference Numerals

101 End user notices reference
102 End user doesn't click link
103 End user clicks link
104 End user pulls up purchasing Dialog box
105 End user is identified by system as a returning user with stored data
106 End user is identified as an individual with no available data
107 End user is directed to enter personal information and choose to store data
108 User enters data and submits
109 The stored or entered information is transmitted to the company
110 User decides not to buy
111 User opts to buy and place the file or files in library
112 User opts to buy and open the file for viewing
113 User selection is transmitted along with pay method to complete transaction
114 Selling company transmits content to be stored in user's library
115 Selling company transmits content which pops up for immediate use for user
200 Indicates a cover or initial landing page for user on the digital content
201 Indicates a page in this case corresponding to the left page of a spread
202 Indicates a page in this case corresponding to the right page of a spread
203 Indicates a linked text which can be clicked to display a purchasing dialog box
204 Indicates a linked image or video which can be clicked to display a purchasing dialog box
205 indicates a purchasing dialog box for user interaction which can be displayed in many forms
301 Illustrates the first panel or picture of a page with many pictures or panels
302 Illustrates the second panel shown behind a pop up of the first panel
303 Illustrates the third panel of the page
304 Illustrates the fourth panel shown behind a pop up of the first panel
305 A pop up or blown up version of the first panel

### DETAILED DESCRIPTION

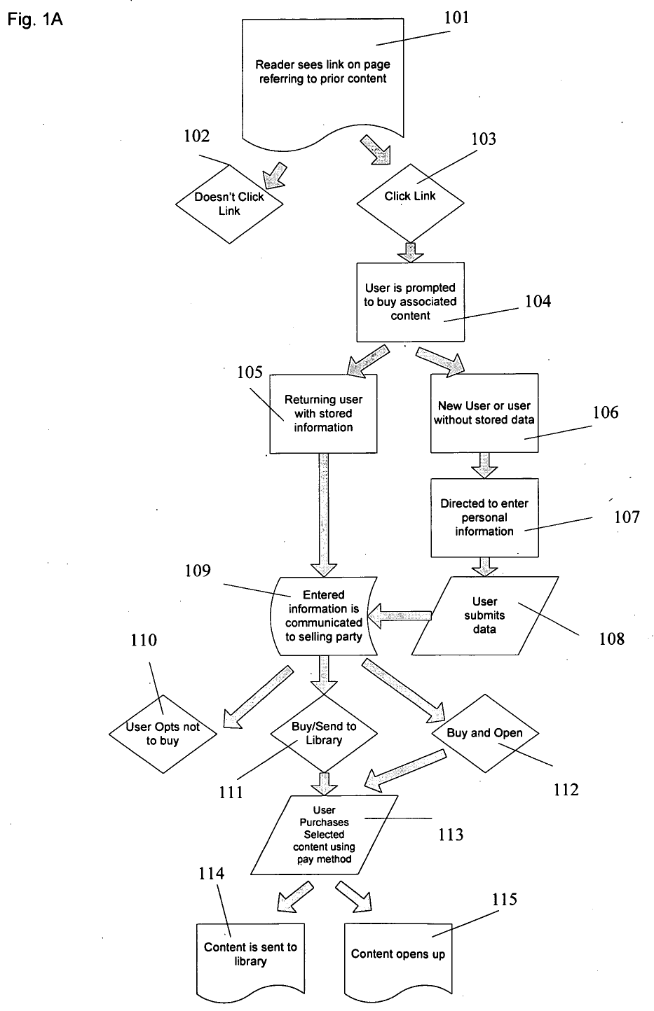

### FIG. 1A

### Preferred Process Flow

A preferred method and system for placing an order for related content by an end-user after being prompted by a referenced link system (software based) is illustrated in FIG. 1.A. Initially, the end user sees or perceives a referenced link which can take the form of text, image, or video 101. The user of the system then decides to click the link 103 or doesn't 102. When the reference link has been clicked it opens up a dialog box to prompt the user to buy the selected referenced content 104. Upon opening, the dialog box determines if the user is a returning user with stored information 105 or is a new user or returning user without stored information 106. When a user is determined to not have any stored information they are directed to a prompt to enter their detailed personal information, or a personal log-in name and password 107. The user then submits their personal information and decides whether they would like to have it saved for next time or not 108. At this point both returning users 105 with stored personal information and those that had to enter their personal information 108 transmit the entered data to the selling party 109. At this point, the user has three choices, consisting of not purchasing the content 110, purchasing the content and directing it to be stored in their library for use at a different time 111, or buying the content for immediate consumption 112. The user then transmits their billing information and agrees to purchase the selected product 113. Once the information is sent to the selling company, the content is then transmitted to the user by going to their library 114 or is opened for immediate viewing 115 as determined by the user previously 111, 112.

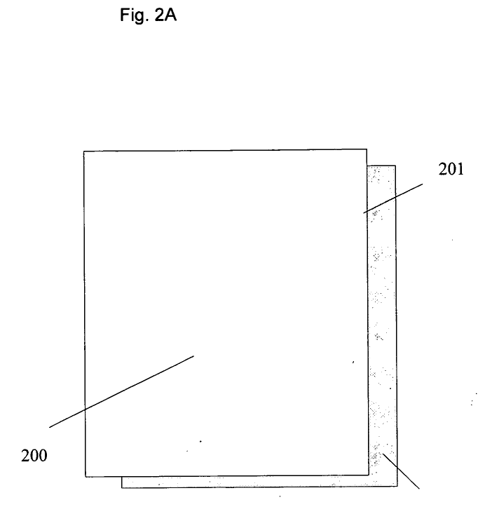

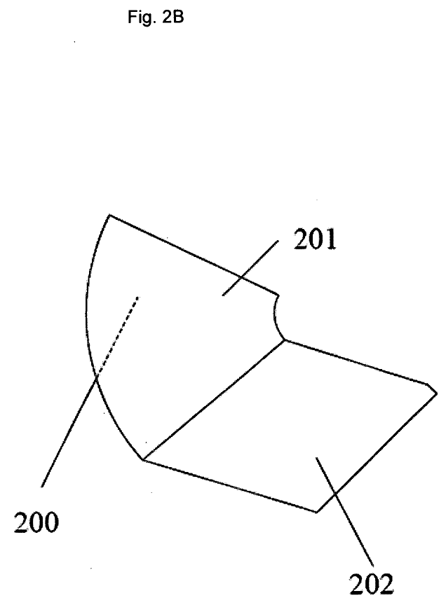

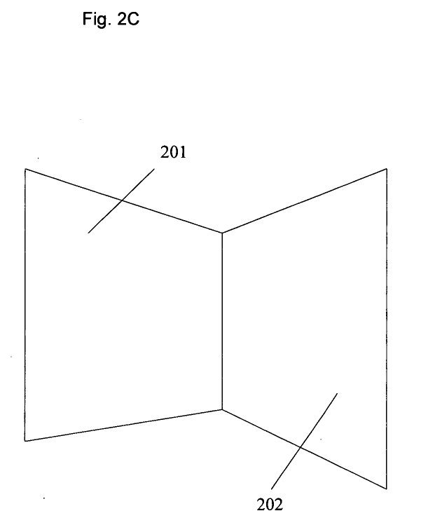

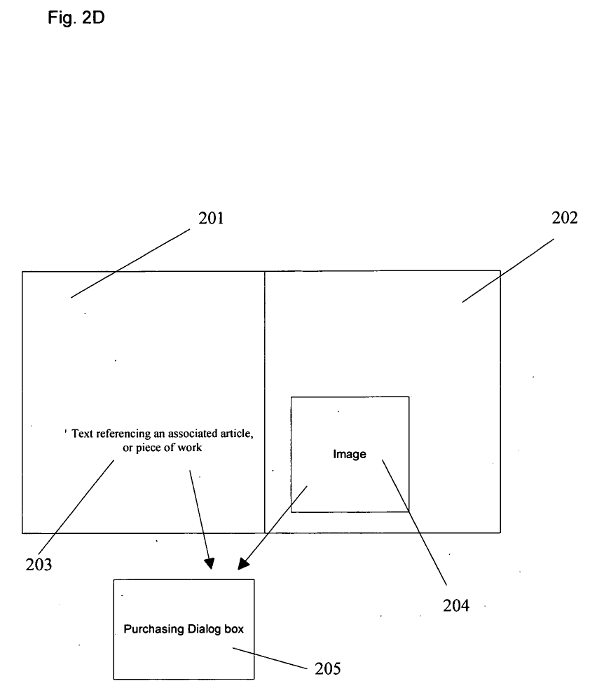

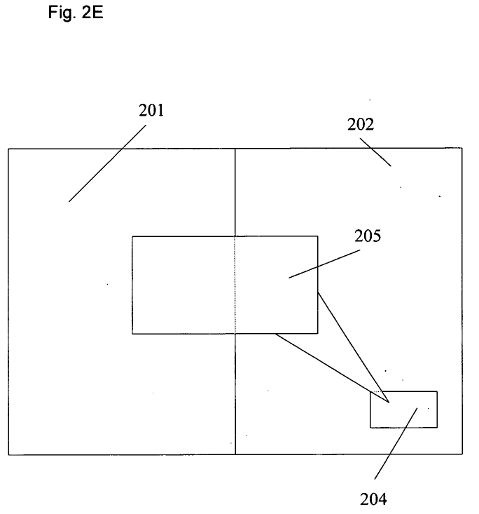

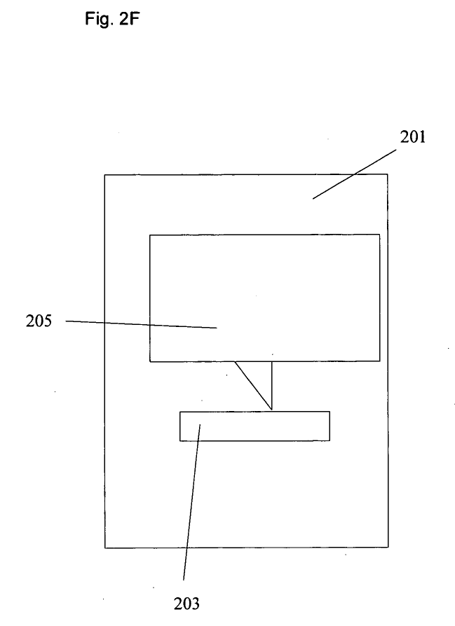

### FIGS. 2.A, 2.B, 2.C, 2.D, 2.E, and 2.F—Visuals of Digital Content Delivery

A preferred visual presentation of digital content in the form of a cover of a book is illustrated in FIG. 2.A (closed book view). The user of the system will view a cover or initial one page view 200 and a clickable or user activated switching mechanism to display the next page 201 or spread of content 201, and 202.

A preferred visual presentation of a user activated switching of content which is illustrated FIG. 2.B (moving page view). The cover or initial landing page 200 which is pushed out of the user's view using a ‘turn page’ style visual, can either be pushed to the left or the right based on reading style user's prefer. While page turning is active the user will begin to see content located on the next page 201 or spread of two pages 202 based on the program's designed user interface.

A preferred visual presentation of digital content in the form of an open standing or open slightly angled reader interface is illustrated in FIG. 2.C (open book view). This view allows the reader to perceive content on both pages 201, and 202 in a visually appealing user interface designed to mimic a traditional reading experience.

A preferred visual presentation of digital content in the form of a flat page or spread of two page reader interface, with a reference linking system to a purchasing dialog box is illustrated in FIG. 2.D (flat two page view). This view allows users to perceive the content on both pages 201, and 202 in a visually appealing, flat view, user interface design. This view also shows two examples of the reference linking technology 203 and 204, which much like current ‘click-through’ technology direct users to additional content. This technology, however, is unique as it is directing users to pre-selected referenced content which is connected with the content that they are currently viewing, with the purpose of selling them additional content that is a reference, like good, or continuation of the content they are viewing. The result of a user activating or clicking the link is a purchasing dialog box 205, also shown. The result of a user activated link 103 leads to the dialog box 205, and will then to place users in the position to purchase additional content as shown in FIG. 1.A 105-on.

A preferred visual presentation of an activated linking reference, in this case an image based reference 204, pulling up a purchasing dialog box 205 is shown in FIG. 2.E (image/video activated dialog box on a two page spread). Located on the second page of the spread is an image which makes use of the referenced linking technology 204. Shown is an activated image link 204 which has pulled up a purchasing dialog box 205 which is then displayed over the two page spread 201 and 202. At this point the user is directed through the buying process as shown in FIG. 1.A 105-on.

Another preferred visual representation of an activated linking reference, in this case a text based reference 203, pulling up a dialog box is shown in FIG. 2.F (image activated dialog box shown on a one page layout). Located on the first page 201 is a text based reference link 203 which is activating a purchasing dialog box 204 that is displayed over a single page layout. At this point the user is directed through the buying process shown in FIG. 1.A 105-on.

### Operation

### FIGS. 1,2.A,B,C,D,E,F

A manner of linking or referencing that is being imbedded into the digital content is consistent with the practice that is currently used on the internet to direct traffic to advertising sites. It differs significantly in that it uses referenced materials included in the digital work to offer the user a method to conduct a transaction that will yield more of the same content, as opposed to pushing them out to a different site that may or may not contain the relevant products. The design is also different in that its design is not disruptive to the user's experience, but built around approaching a captive audience with an extremely relevant product that directly adds to their experience (as shown in FIG.

The referenced link system solves a problem associated with the costs of digitizing content and making it available for a wide audience by using existing references or adding references which can be used to offer a better user experience than current print or digital versions can offer (shown in FIG. 2.A-F). By introducing a new way for users to view, and purchase this content digitally, the model described herein allows for a richer user experience, resulting in the content providers increased ability to sell more product to a captive audience.

The buying process laid out in FIG. 1.A is designed in such a way as to reduce the level of intrusion the end user experiences while they are immersed in the content they are viewing 200, 201, and 202. The reference links found on the pages 203, 204 and also 101 engage the reader as they are directly tied to the content they are enjoying, allowing them the opportunity to gain additional content relevant to what they are currently using.

Through an opt-in model of ‘clicking’ 103 or user activation of the referenced link, the seller doesn't intrude on the user experience, but rather enables the user to increase their enjoyment of content by expanding what is available to them. Allowing the user to choose to store information 105 or submit data each time 106-108 gives the purchasing program the versatility to meet different customer needs, allowing for streamlined purchasing as well as considering a user's preference not to store sensitive data. Last, allowing the user to decide whether to immediately display the newly purchased content 112 or to store it for later use in a library 111 gives the end user control on how they will consume or use the products they purchase. By providing the streamlined process discussed above, companies give consumers more reason to switch to digitized content, thereby reducing their costs of distribution. The value added to the consumer to instantly receive additional content will help the transition from printed materials, something that will be needed for online publishing to become very profitable.

As shown in FIG. 2.A,B,C,D,E,and F, a user interface that is familiar to users and mimics traditional publishing is necessary to entice change. People have a tendency to be averse to change, and are usually more comfortable with things that are known or familiar. By keeping with a standard book or comic book format, the end user can be comfortable enough to begin adapting to this new publication method. The linking technologies discussed on FIG. 2.D,E,F are used in such a way as to work with the purchasing process shown in FIG. 1.A, to be as non-invasive as possible to the user's experience. If the user experience becomes convoluted or too cluttered, it could turn off users and result in a slower adoption of digital publishing. By using traditional text linking 203, or picture linking 204, but using them in a targeted purchasing model, as opposed to a targeted or non-targeted advertising model, companies can make more money without disrupting the user experience.

### ADDITIONAL EMBODIMENTS

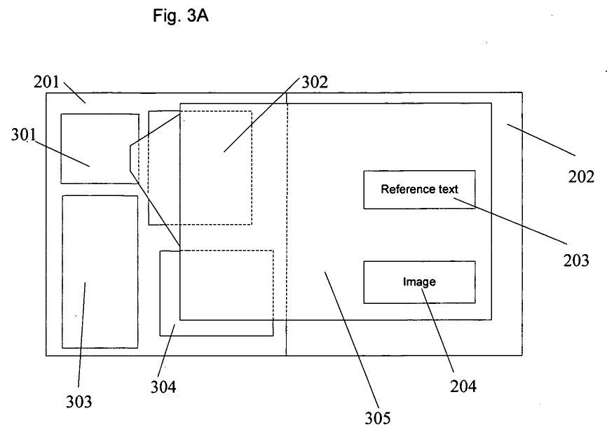

### FIG. 3.A

In addition to the linking technology being used as a mechanism to conduct additional purchases, the referencing technology can also be used as illustrated in FIG. 3.A. In the illustration a panel 301 or picture is blown up 305 to allow a user to view the content in more detail, and to ease reading. One of the reasons for slow adoption of published content to cell phones, televisions or computers is that the content might be hard for some users to see, or read without strain: using the technology 305 specified could lead to a better user experience. While using the reference linking technology to blow up the picture 305, it should be noted that it would still be possible to use the reference linking 203, or 204 inside the blown up picture as shown in FIG. 3.A to still purchase additional content.

### ALTERNATIVE EMBODIMENTS

### FIGS. 2.D,E,F

As seen in FIGS. 2.D,E,F one can place a hyperlink, or some other embedded linking into a piece of digital content. One easy way of getting around the proposed patent would be to hyperlink to a separate website and have it pull up another window. This is pretty much the same process that has been described but without the added benefit of not disrupting the end user's experience. Where possible, redirecting the audience away from the content should be avoided as this causes confusion as well as limits the experience.

It is also possible to embed the linking into the program (reader) instead of the file, but this is an obvious attempt to circumvent the general business model and is not innovative as it is, in effect, doing the same thing.

Another option that circumvents this process would be to just keep a website with the content on it. While this is unique and it does offer it's own advantages, it doesn't allow for the captive audience the way that the reference linking model does, which is why reference linking built into content is of economic value.

I claim:

1. Process of automatically inserting a link into a digital file to open up a transaction window.

2. Given claim 1 where a digital file is transmitted/transferred, downloaded or streamed to the end-user.

3. Given claim 1 where the link is a reference within the work or file pointing to a complementary or referenced work.

4. Given claim 1 where the link can be a moving picture, portion of the picture, still picture or text that activates the transaction window.

5. Given claim 1 where the transaction can be a subscription to the referenced work.

6. Given claim 1 where the transaction window can remember and use stored end-user information required to complete the transaction.
